(19) United States
(12) Patent Application Publication
(10) Pub. No.: US 2026/0025210 A1
(43) Pub. Date: Jan. 22, 2026

(54) OPTICAL RECEIVER AND OPTICAL RECEVING METHOD

(71) Applicant: Fujitsu Limited, Kawasaki-shi (JP)

(72) Inventors: Hisao NAKASHIMA, Kawasaki (JP); Hiroyuki IRIE, Kawasaki (JP); KIICHI SUGITANI, Fukuoka (JP); Yasutaka KANAYAMA, Inagi (JP); Tatsuro KISHIDA, Fukuoka (JP); Yutaka KOSUGE, Ashikaga (JP)

(73) Assignee: Fujitsu Limited, Kawasaki-shi (JP)

(21) Appl. No.: 19/338,683

(22) Filed: Sep. 24, 2025

Related U.S. Application Data
(63) Continuation of application No. PCT/JP2024/008112, filed on Mar. 4, 2024.

(30) Foreign Application Priority Data
Mar. 31, 2023 (JP) 2023-057784

(51) Int. Cl. H04B 10/61

(52) U.S. Cl. CPC H04B 10/6161

(57) ABSTRACT

An optical receiver includes a dispersion compensation circuit that compensates for chromatic dispersion of an optical transmission line, for an electric signal corresponding to an optical signal received through the optical transmission line, an adaptive equalization circuit that adaptively compensates for residual chromatic dispersion remaining due to insufficient compensation in the dispersion compensation circuit, for a compensated electric signal by the dispersion compensation circuit, and a monitor circuit that monitors a dispersion slope of the residual chromatic dispersion based on a tap coefficient of the adaptive equalizer circuit. The dispersion compensation circuit compensates for the chromatic dispersion based on a monitor value of the dispersion slope.

### CROSS-REFERENCE TO RELATED APPLICATION

This application is a continuation application of International Patent Application No. PCT/JP2024/008112, filed on Mar. 4, 2024, which claims priority to Japanese Patent Application No. 2023-057784 filed on Mar. 31, 2023, subject matter of these documents is incorporated.

### FIELD

A certain aspect of embodiments described herein relates to an optical receiver and an optical receiving method.

### BACKGROUND

In a wavelength division multiplexing optical transmission system of 40 Gbit/s or more, a system for performing dispersion compensation for a contained wavelength band at a time is known. In recent years, it has become possible to compensate for the chromatic dispersion accumulated in the optical receiver by the digital signal processing technique. In a wavelength division multiplexing optical transmission system, a transmission distance and a transmission capacity are greatly limited by a chromatic dispersion slope (hereinafter simply referred to as a dispersion slope) which is a high-order dispersion of chromatic dispersion of an optical fiber. Therefore, it is important to accurately grasp the dispersion value and the dispersion slope of the optical transmission line and to perform dispersion compensation including the dispersion slope (see Japanese Patent Application Publications No. 2003-273804 and No. 2006-333312).

### SUMMARY

According to an aspect of the embodiments, there is provided an optical receiver including: a dispersion compensation circuit that compensates for chromatic dispersion of an optical transmission line, for an electric signal corresponding to an optical signal received through the optical transmission line, an adaptive equalization circuit that adaptively compensates for residual chromatic dispersion remaining due to insufficient compensation in the dispersion compensation circuit, for a compensated electric signal by the dispersion compensation circuit, and a monitor circuit that monitors a dispersion slope of the residual chromatic dispersion based on a tap coefficient of the adaptive equalizer circuit, wherein the dispersion compensation circuit compensates for the chromatic dispersion based on a monitor value of the dispersion slope.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of a wavelength division multiplexing optical transmission system.

FIG. 2 illustrates an example of a block diagram of an optical receiver.

FIG. 3 illustrates a block diagram of a digital signal processor (DSP).

FIG. 4 is a graph for explaining an example of a decrease in transmission characteristics due to a dispersion slope.

FIG. 5A is a graph showing monitor values of residual chromatic dispersion for a transmission distance.

FIG. 5B is a graph showing monitor values of residual chromatic dispersion for a transmission distance.

FIG. 5C is a graph showing monitor values of residual chromatic dispersion for a transmission distance.

FIG. 6 is a diagram for explaining a range of a signal band.

FIG. 7 is a diagram for explaining determination of a range of a signal band.

FIG. 8A is a graph showing an example of a monitor value of residual chromatic dispersion.

FIG. 8B is a graph showing another example of the monitor value of the residual chromatic dispersion.

FIG. 9 is a flowchart showing an example of processing of the monitor circuit.

FIG. 10A is a graph showing an example of the monitor value of the residual chromatic dispersion at a high baud rate.

FIG. 10B is a graph showing another example of the monitor value of the residual chromatic dispersion at a low baud rate.

FIG. 11A is a diagram for explaining an example of division of an optical signal when subcarrier modulation is applied.

FIG. 11B is a diagram showing an example of calculation of the dispersion slope when subcarrier modulation is applied.

### DESCRIPTION OF EMBODIMENTS

There are cases where various kinds of optical transmission lines are mixed between an optical transmitter and an optical receiver included in a wavelength division multiplexing optical transmission system. For example, optical fibers such as Enhanced Large Effective Area Fibers (ELEAFs) and Single-Mode Fibers (SMFs) are intermingled as optical transmission lines between the optical transmitter and the optical receiver. Optical transmission lines of various lengths are also present between the optical transmitter and the optical receiver.

The type and length of the optical transmission line described above are not always known, and may be partially unknown. When the type and length of the optical transmission line are unknown, it is difficult for the optical receiver to accurately grasp the dispersion value and dispersion slope of the optical transmission line. As a result, it is difficult for the optical receiver to perform dispersion compensation with high accuracy including the dispersion slope, and there is a problem that the transmission characteristic of the optical signal is deteriorated.

Hereinafter, a description will be given of embodiments of the present disclosure with reference to the accompanying drawings.

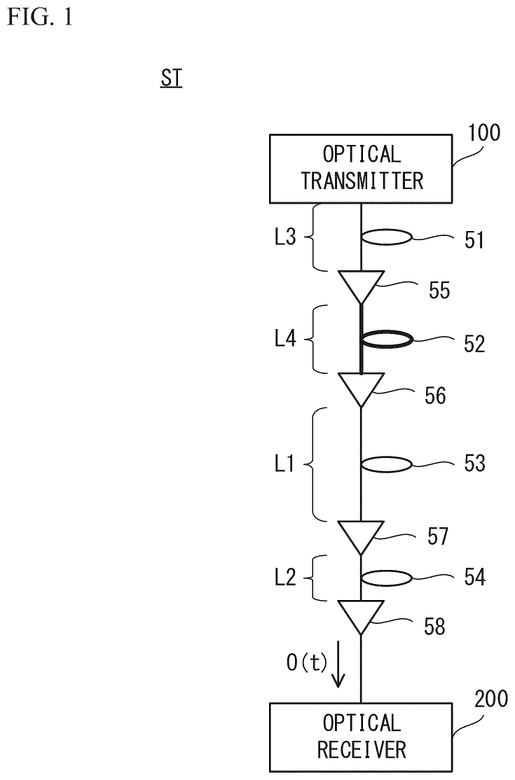

As shown in FIG. 1, the wavelength division multiplexing optical transmission system ST includes an optical transmitter 100 and an optical receiver 200. The optical receiver 200 receives the optical signal O(t) transmitted from the optical transmitter 100. The optical signal O(t) is a signal output from the optical transmitter 100 and can be expressed as a function of time t. Although FIG. 1 shows a wavelength division multiplexing optical transmission system ST including one optical transmitter 100 and one optical receiver 200, there is also a case where a plurality of different wavelengths is multiplexed to perform optical transmission. In this case, the wavelength division multiplexing optical transmission system ST includes a plurality of optical transmitters and a plurality of optical receivers, demultiplexes the optical signal O(t) into optical signals of respective wavelengths, and multiplexes the optical signals of respective wavelengths to generate the optical signal O(t). The optical transmitter 100 and the optical receiver 200 are connected to each other by various kinds of optical fibers 51, 52, 53,54 and a plurality of optical amplifiers 55, 56, 57, 58. The optical fibers 51, 52, 53, 54 are an example of an optical transmission line. For example, the optical fiber 51 is an SMF. The optical fibers 52 are an ELEAF. The optical fibers 53, 54 are all unspecified optical fibers of which the type is not clear.

The optical fibers 51, 52, 53, 54 of various lengths are used for connection between the optical transmitter 100 and the optical receiver 200. For example, the length L1 of the optical fiber 53 is 80 km (kilometers). The length L2 of the optical fiber 54 is 30 km. On the other hand, neither the length L3 of the optical fiber 51 nor the length L4 of the optical fiber 52 is known. In this way, in the wavelength division multiplexing optical transmission system ST, the type of the optical fibers 53, 54 may not be known, or the length L3 of the optical fiber 51 or the length L4 of the optical fiber 52 may not be known.

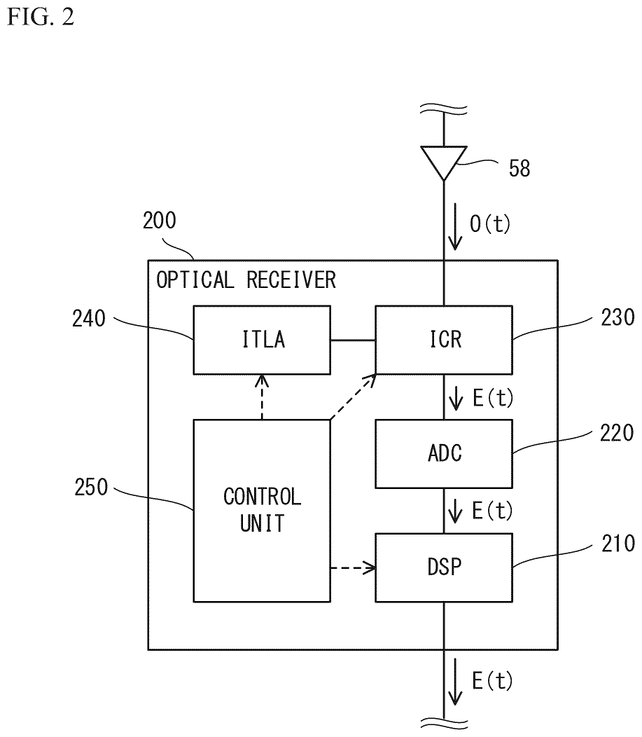

Next, the details of the optical receiver 200 will be described with reference to FIG. 2.

The optical receiver 200 includes a DSP 210, an analog-to-digital converter (ADC) 220, an integrated coherent receiver (ICR) 230, an integrable tunable laser assembly (ITLA) 240, and a control unit 250.

The optical signal O(t) transmitted from the optical transmitter 100 is input to the ICR 230. The ICR 230 includes a polarization beam splitter and an opto-electrical converter. The ICR 230 separates the optical signal O(t) into H-polarized wave and V-polarized wave components, mixes the components with the local light input from the ITLA240 to extract information corresponding to the optical signal O(t), converts the information into an electric signal (specifically, an electric field signal) E(t), and outputs the electric signal to the ADC 220. The electrical signal E(t) converted from the optical signal O(t) can be expressed as a function of time t.

The ADC 220 converts the electric signal E(t) from an analog form to a digital form and outputs the digital signal to the DSP 210. As will be described in detail later, the DSP 210 performs various digital signal processing for the electric signal E(t), such as compensating for the chromatic dispersion of the optical fibers 51, 52, 53, 54 and outputs the signal. The control unit 250 includes a processor and a memory, and controls the operations of the DSP 210, the ICR 230, and the ITLA 240.

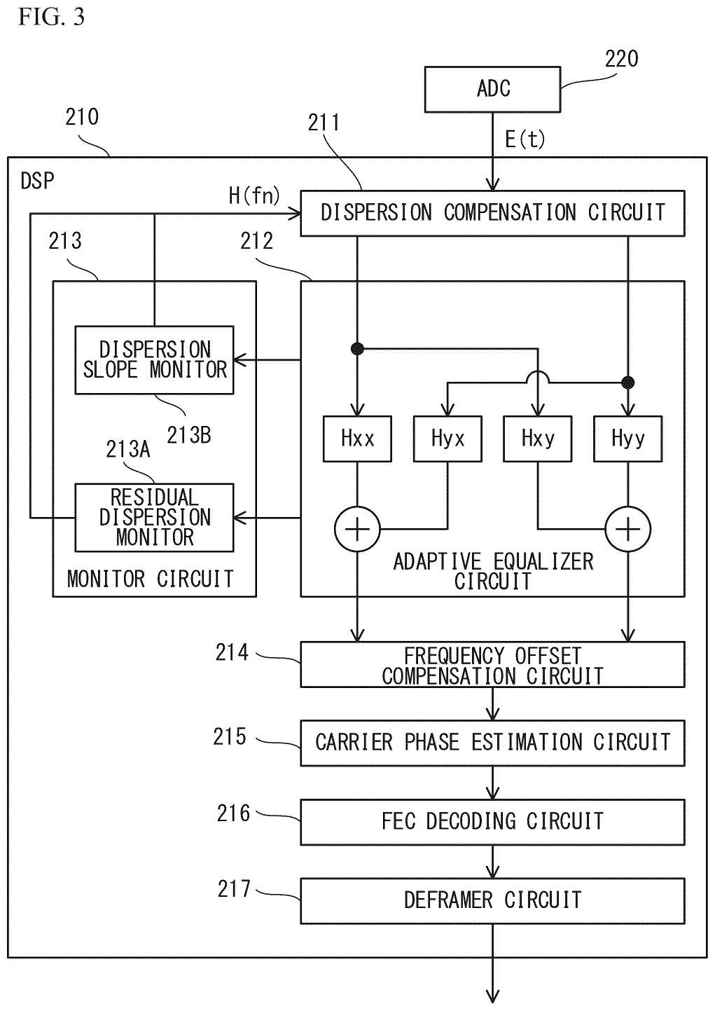

Referring to FIG. 3, the DSP 210 will be described in detail.

The DSP 210 includes a dispersion compensation circuit 211, an adaptive equalization circuit 212, a monitor circuit 213, and a frequency offset compensation circuit 214. The DSP 210 also includes a carrier phase estimation circuit 215, a forward error correction (FEC) decoder circuit 216, and a deframer circuit 217. The control unit 250 may include the monitor circuit 213 instead of the monitor circuit 213 of the DSP 210. In this case, the control unit 250 may execute a process according to a flowchart described later.

The dispersion compensating circuit 211 fixedly and collectively compensates for the accumulated chromatic dispersion of the optical fibers 51, 52, 53, 54 for the electric signal E(t) input from the ADC 220. For example, the dispersion compensation circuit 211 performs a fast Fourier transform (FFT) for the input electric signal E(t) to convert the electric signal E(t) into a frequency domain signal. Next, the dispersion compensation circuit 211 multiplies the frequency domain signal by an inverse transfer function H(fn) input from the monitor circuit 213 as a dispersion compensation coefficient, thereby fixedly compensating for the chromatic dispersion. The dispersion compensating circuit 211 performs an inverse FFT (IFFT) for a compensated frequency domain signal, thereby compensating for the waveform distortion due to the chromatic dispersion of the received electric signal E(t) represented by the function of the time t and outputting to the adaptive equalization circuit 212.

The inverse transfer function H(fn) can be expressed by the following formula (1). The second order chromatic dispersion is the term related to the dispersion slope.

$$H ( fn ) = exp [ j * \{ 1 / 2 * {( 2 π * fn )}^{2} * C * 1 st order chromatic dispersion / ( 2 π * {Fc}^{2} ) + 1 / 6 * {( 2 π * fn )}^{3} * C * ( C / Fc * 2 nd order chromatic dispersion + 2 * 1 st order chromatic dispersion ) / ( {( 2 π )}^{2} * {Fc}^{3} ) \} ] \qquad Formula ( 1 )$$

C: Speed of light
Fc: Signal frequency
1st order chromatic dispersion: reciprocal of cumulative chromatic dispersion of optical fibers 51, 52, 53, 54 (ps/nm)
2nd order chromatic dispersion: reciprocal of cumulative secondary chromatic dispersion of optical fibers 51, 52, 53, 54 (ps/nm²)
fn=n*sampling rate/N_FFT (where n is an integer, 0 to N_FFT/3, −(N_FFT/2)+1 to −1)
J: imaginary unit

The adaptive equalizer circuit 212 adaptively compensates for waveform distortion in accordance with distortion mainly caused by polarization fluctuation or polarization mode dispersion of the optical fibers 51, 52, 53, 54. The adaptive equalizer circuit 212 may include a digital filter circuit such as a finite impulse response (FIR) filter.

The adaptive equalizer circuit 212 adaptively compensates for residual chromatic dispersion remaining due to insufficient compensation in the dispersion compensation circuit 211 in two systems of complex time series which are the electric signals E(t) after the chromatic dispersion compensation in the dispersion compensation circuit 211. The dispersion compensation circuit 211 performs dispersion compensation by monitoring the information on the amount of chromatic dispersion of the transmission line, but if the information is uncertain, the dispersion compensation may not be completely performed. Therefore, the adaptive equalizer circuit 212 adaptively compensates the residual chromatic dispersion for the compensated electric signal E(t).

The adaptive equalizer circuit 212 compensates for distortion and residual chromatic dispersion due to polarization fluctuation and polarization mode dispersion, and outputs the compensated electric signal E(t) to the frequency offset compensation circuit 214. The frequency offset compensation circuit 214 compensates for the frequency shift (offset) between the optical signal O(t) and the local light emission based on the compensated electric signal E(t), and outputs the compensated signal to the carrier phase estimation circuit 215. The carrier phase estimation circuit 215 estimates a correct carrier phase from the compensated electric signal E(t) and performs recovery of a carrier phase. The carrier phase estimation circuit 215 restores the transmission signal from the estimated carrier phase, and outputs the restored electric signal E(t) to the FEC decoding circuit 216.

The FEC decoding circuit 216 performs error correction decoding of the electric signal E(t) based on an error correction code added to the optical signal O(t) by digital signal processing in the optical transmitter 100, for example. The deframer circuit 217 performs deframer processing for the electric signal E(t). The deframer process is a process of demapping the client signal mapped to the frame of the electric signal E(t). The client signal may be an Ethernet (trademark) frame signal, or a synchronous digital hierarchy (SDH) or a synchronous optical network (SONET) frame signal.

Here, the monitor circuit 213 estimates and monitors the residual chromatic dispersion based on the tap coefficients Hxx, Hxy, Hyx, and Hyy of the adaptive equalizer circuit 212, and calculates the residual chromatic dispersion and a dispersion slope which is the wavelength derivative of the residual chromatic dispersion based on the monitor value of the residual chromatic dispersion. More specifically, a residual dispersion monitor 213A of the monitor circuit 213 estimates and monitors the residual chromatic dispersion, and calculates and determines the residual chromatic dispersion based on the monitor value of the residual chromatic dispersion. Then, a dispersion slope monitor 213B of the monitor circuit 213 calculates and determines the dispersion slope based on the monitor value of the residual chromatic dispersion. After the residual chromatic dispersion and the dispersion slope are determined, the monitor circuit 213 calculates the inverse transfer function H(fn) based on the above formula (1), with the residual chromatic dispersion being the first order chromatic dispersion and the dispersion slope being the second order chromatic dispersion.

The estimation of the residual chromatic dispersion by the residual dispersion monitor 213A is disclosed in, for example, the following literature. On the other hand, the calculation of the dispersion slope by the dispersion slope monitor 213B is not disclosed in the following documents, and is not publicly known.
(1) Md. Saifuddin Faruk, et al, “Multi-Impairments Monitoring from the Equalizer in a Digital Coherent Optical Receiver”, ECOC 2010, Th.10.A.1, 19-23 Sep. 2010, Torino, Italy
(2) Gabriella Bosco, et al, “Joint DGD, PDL and Chromatic Dispersion Estimation in Ultra-Long-Haul WDM Transmission Experiments with Coherent Receivers”, ECOC 2010, Th. 10.A.2, 19-23 Sep. 2010, Torino, Italy

The monitor circuit 213 calculates the inverse transfer function H(fn) and inputs the inverse transfer function H(fn) as a dispersion compensation coefficient to the dispersion compensation circuit 211. Thus, the dispersion compensation circuit 211 can compensate not only the first order chromatic dispersion such as the residual chromatic dispersion but also the chromatic dispersion considering the high-order (specifically, second order) chromatic dispersion such as the dispersion slope.

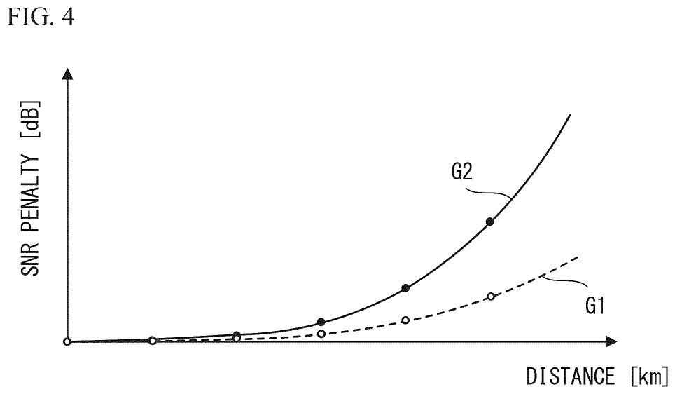

Referring to FIG. 4, the deterioration of the transmission characteristic of the optical signal O(t) due to the dispersion slope will be described.

It is known that the chromatic dispersion of the optical fibers 51, 52, 53, 54 have frequency dependence, and this frequency dependence can be expressed by a dispersion slope. When the optical receiver 200 receives the optical signal O(t) of a low baud rate such as 32 Gbaud or 64 Gbaud, the range of the signal band of the optical signal O(t) is narrow, and therefore, it is considered that the chromatic dispersion is constant within the range of the signal band. Therefore, the influence of the dispersion slope on the transmission characteristic of the optical signal O(t) is assumed to be small and can be ignored.

On the other hand, when the optical receiver 200 receives the optical signal O(t) having a high baud rate exceeding 100 Gbaud, the optical signal O(t) has a wide range of signal band, and therefore, the chromatic dispersion is not constant within the range of signal band, and is considered to vary. Therefore, it is assumed that the influence of the deterioration of the transmission characteristic of the optical signal O(t) due to the dispersion slope is large. For example, as shown in FIG. 4, when the optical receiver 200 receives the optical signal O(t) of 130 Gbaud optically modulated by the optical modulation method of 16 QAM, a large difference appears in the transmission characteristic of the optical signal O(t) between the optical fibers 51, 52.

More specifically, a graph G1 representing the transmission characteristics of the optical fiber 51 as the SMF shows that Signal to Noise Ratio (SNR) penalty increases slowly with respect to the increase in the transmission distance. The SNR penalty increases slowly. That is, the graph G1 has a gentle gradient. In this way, in the case of the optical fiber 51, even if the transmission distance increases, the influence of the dispersion slope, which is the wavelength derivative of the chromatic dispersion, is small, and therefore, the SNR penalty is small, and it is assumed that the deterioration of the transmission characteristic is small.

On the other hand, the graph G2 representing the transmission characteristics of the optical fibers 52 as the ELEAF shows that the SNR penalty sharply increases in the ultra-long distance region with respect to the increase in the transmission distances. That is, the graph G2 is steep. In this way, in the case of the optical fiber 52, it is assumed that when the transmission distance increases, the SNR penalty is large because the influence of the dispersion slope is large, and the transmission characteristic is greatly deteriorated. For example, when the transmission distance is in the vicinity of 6000 km, the transmission characteristic of the optical fiber 51 is reduced by about 1.5 dB due to the dispersion slope, but the transmission characteristic of the optical fiber 52 is reduced by 3.0 dB or more due to the dispersion slope.

When the type and length of the optical fibers 51, 52 are known, the dispersion slope can be calculated with high accuracy by the fiber specification, and as a result, the compensation for the dispersion slope can be prepared and performed in advance. However, when the optical fibers 53, 54 whose type and length are not known is included in the connection between the optical transmitter 100 and the optical receiver 200, the dispersion slope is also indefinite and cannot be calculated with high accuracy. As a result, it is difficult to prepare and perform compensation for the dispersion slope in advance.

In present embodiment, when the connection between the optical transmitter 100 and the optical receiver 200 includes, for example, the optical fibers 53, 54 of an unknown type or the optical fibers 51, 52 of an unknown length, dispersion compensation is realized in consideration of a case where both the accumulated residual chromatic dispersion and the dispersion slope are indefinite.

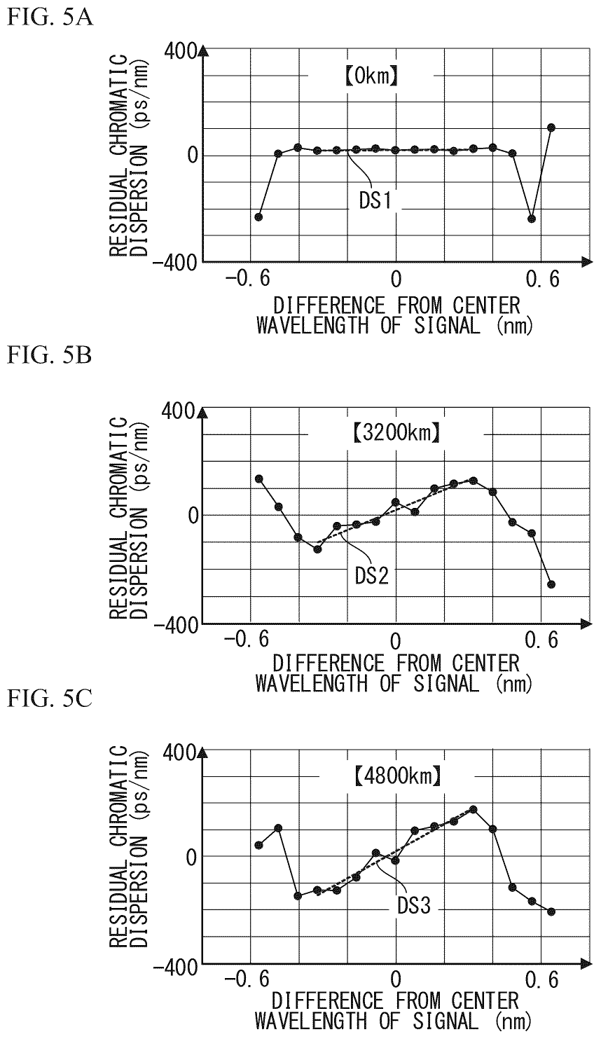

Referring to FIGS. 5A to 5C, the relationship between the residual chromatic dispersion and the dispersion slope monitored by the monitor circuit 213 for each transmission distance will be described. In FIGS. 5A to 5C, the relationship between the difference from the center wavelength of the optical signal O(t) and the residual chromatic dispersion is shown in the case where the optical transmitter 100 and the optical receiver 200 are connected by the optical fiber 52, and the first order chromatic dispersion is compensated by the dispersion compensation circuit 211.

First, as shown in FIG. 5A, when the transmission distance is 0 km, the variation of the residual chromatic dispersion is small and constant around 0 ps/nm in the range of the difference from the center wavelength from −0.3 nm (nano meter) to 0.3 nm. That is, when the transmission distance is 0 km, the gradient of the dispersion slope DSI is almost zero, and the frequency dependence of the residual chromatic dispersion is zero or small.

Next, as shown in FIG. 5B, when the transmission distance is 3200 km, the residual chromatic dispersion varies in the range from −0.3 nm to 0.3 nm from the center wavelength. Specifically, the residual chromatic dispersion is in the vicinity of −100 ps/nm at around −0.3 nm and in the vicinity of 100 ps/nm at around 0.3 nm. In this way, when the transmission distance is 3200 km, the dispersion slope DS2 is inclined upward from the dispersion slope DS1, and a larger gradient than the dispersion slope DS1 is generated in the dispersion slope DS2. That is, it is found that the frequency dependence of the residual chromatic dispersion increases as the transmission distance increases.

Further, as shown in FIG. 5C, when the transmission distance is 4800 km, the residual chromatic dispersion varies in the range from −0.3 nm to 0.3 nm from the center wavelength. Specifically, the residual chromatic dispersion is about −100 ps/nm at about −0.3 nm and about 190 ps/nm at about 0.3 nm. In this way, when the transmission distance is 4800 km, the dispersion slope DS3 is inclined to the right upward from the dispersion slope DS2, and a gradient larger than the dispersion slope DS2 is generated in the dispersion slope DS3. That is, it is found that the frequency dependence of the residual chromatic dispersion further increases as the transmission distance increases.

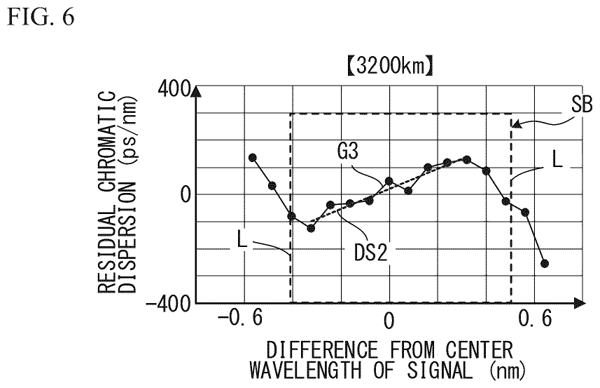

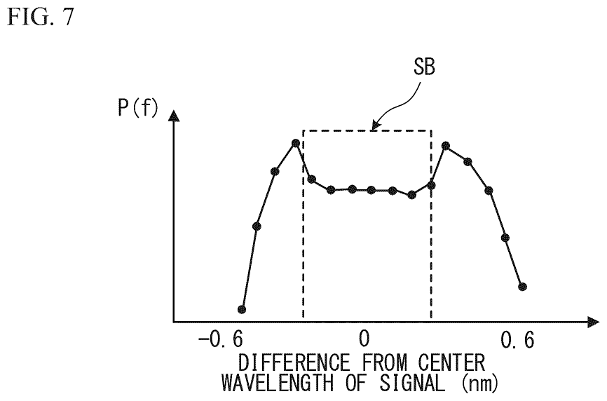

Next, a dispersion slope estimation method according to the present embodiment will be described with reference to FIGS. 6 and 7.

As described above, since the residual chromatic dispersion is estimated and monitored by the residual dispersion monitor 213A, the dispersion slope monitor 213B estimates the dispersion slope DS2 by using the line graph G3 representing the monitor value of the residual chromatic dispersion as shown in FIG. 6. In the region outside the vicinity of the limit L of the signal band SB of the optical signal O(t), the residual dispersion monitor 213A performs the operation of suppressing the noise outside the signal band, and therefore, the accuracy of the monitor value is lowered. Even inside the vicinity of the limit L of the signal band SB, the variation of the residual chromatic dispersion becomes large due to the influence of the monitor accuracy and the frequency resolution.

The dispersion slope monitor 213B approximates the line graph G3 of the monitor value of the residual chromatic dispersion, in which the dispersion becomes large inside the vicinity of the limit L of the signal band SB, to a linear function to estimate the dispersion slope DS2. The line graph G3 may be approximated to a linear function by using, for example, the least square method. For example, when the linear function is expressed by y=ax+b, the coefficient a can be associated with the dispersion slope, and the coefficient b can be associated with the residual chromatic dispersion. In this way, the dispersion slope monitor 213B calculates and determines the coefficient a corresponding to the dispersion slope and the coefficient b corresponding to the residual chromatic dispersion.

The dispersion slope monitor 213B can determine the range of the signal band SB approximating the line graph G3 to a linear function based on the monitor value of the transmission band of the transceiver or the transmission line, for example. More specifically, the dispersion slope monitor 213B calculates the monitor value M(f) of the transmission band based on the following formula (2).

$$M ( f ) = Hxx ( f ) * Hyy ( f ) - Hyx ( f ) * Hxy ( f ) \qquad Formula ( 2 )$$

Hxx(f), Hyy(f), Hyx(f), and Hxy(f) represent the inverse transfer functions of the tap coefficients Hxx, Hyy, Hyx, and Hxy, respectively.

After the monitor value M(f) is calculated, the dispersion slope monitor 213B calculates the inverse characteristic P(f) of the transmission band based on the following formula (3).

$$P ( f ) = 10 * log ( abs ( M ( f ) ) ) \qquad Formula ( 3 )$$

When the inverse characteristic P(f) of the transmission band is calculated, the dispersion slope monitor 213B determines a range in which P(f) is constant as the range of the signal band SB, as shown in FIG. 7. This is because the monitor value of the residual chromatic dispersion often falls within a range where the residual chromatic dispersion linearly changes. On the other hand, the dispersion slope monitor 213B may determine the range of the signal band SB as the range between inflection points where P(f) becomes convex upward. This is because the range is close to the range of the actual signal band SB. In this way, the dispersion slope monitor 213B determines the range of the signal band SB, approximates the monitor value of the residual chromatic dispersion included in the range to a linear function, and calculates and determines the residual chromatic dispersion and the dispersion slope based on the linear function.

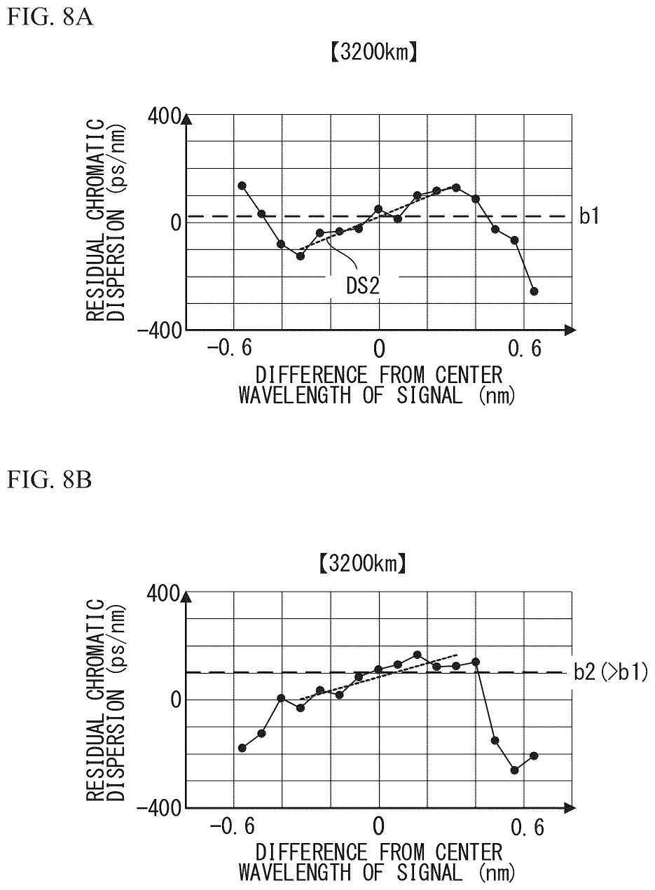

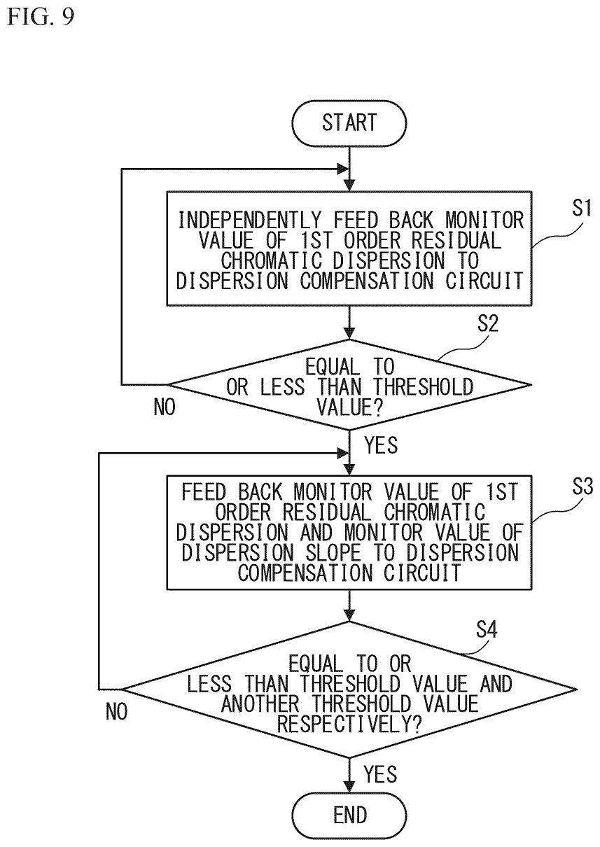

Next, the influence of the first order residual chromatic dispersion will be described with reference to FIGS. 8A, 8B and 9.

First, as shown in FIG. 8A, depending on the compensation by the dispersion compensation circuit 211, the coefficient b corresponding to the first order residual chromatic dispersion may be a very small coefficient such as a coefficient b1 (for example, 20 ps/nm) at a difference of 0 nm from the center wavelength. That is, there is a case where the dispersion compensation circuit 211 sufficiently compensates the dispersion, and therefore the first order residual chromatic dispersion is almost zero and the dispersion becomes close to 0 ps/nm. In this way, in a state where the first order residual chromatic dispersion is close to 0 ps/nm, the dispersion slope monitor 213B can calculate the dispersion slope DS2 with high accuracy.

However, as shown in FIG. 8B, depending on the compensation by the dispersion compensation circuit 211, there is a case where the coefficient b corresponding to the first order residual chromatic dispersion becomes a large coefficient such as a coefficient b2 (for example, 100 ps/nm) larger than the coefficient b1 at a difference of 0 nm from the center wavelength. That is, the dispersion compensation circuit 211 may not sufficiently compensate the first order residual chromatic dispersion, so that the first order residual chromatic dispersion may increase and be greatly separated from 0 ps/nm. In this way, in a state where the residual chromatic dispersion is far from 0 ps/nm, the dispersion slope monitor 213B may not be able to calculate the dispersion slope DS2 with high accuracy.

Therefore, as shown in FIG. 9, in the monitor circuit 213, first, the residual dispersion monitor 213A independently feeds back the monitor value of the first order residual chromatic dispersion to the dispersion compensation circuit 211 (step S1). Then, the residual dispersion monitor 213A determines whether or not the monitor value of the first order residual chromatic dispersion of the compensated electric signal E(t) restored by the dispersion compensation circuit 211 is equal to or less than a threshold value for determining the small residual chromatic dispersion (step S2). The threshold value may be, for example, 20 ps/nm as described above. When the monitor value of the first order residual chromatic dispersion is not equal to or less than the threshold value (step S2: NO), the residual dispersion monitor 213A executes the processing of step S1 again.

In this way, by repeating the processing of step S1 and step S2 until the monitor value of the first order residual chromatic dispersion becomes equal to or less than the threshold value, the first order residual chromatic dispersion converges to equal to or less than the threshold value, and it is possible to suppress a decrease in the calculation accuracy of the dispersion slope.

When the monitor value of the first order residual chromatic dispersion becomes equal to or less than the threshold value (step S2: YES), the residual dispersion monitor 213A and the dispersion slope monitor 213B feed back the monitor value of the first order residual chromatic dispersion and the monitor value of the dispersion slope to the dispersion compensation circuit 211, respectively (step S3). The residual dispersion monitor 213A determines whether or not the monitor value of the first residual chromatic dispersion of the electric signal E(t) after the chromatic dispersion compensation of the transmission line by the dispersion compensation circuit 211 is equal to or less than the above-described threshold value and whether or not the monitor value of the dispersion slope is equal to or less than another threshold value (step S4). another threshold value is a threshold value for determining the small dispersion slope, and may be, for example, 5 ps/nm² or 10 ps/nm².

When the monitor value of the first order residual chromatic dispersion is not equal to or less than the threshold value, or when the monitor value of the dispersion slope is not equal to or less than another threshold value (step S4: NO), the residual dispersion monitor 213A and the dispersion slope monitor 213B respectively execute the processing of step S3 again. Since the processing of steps S3 and S4 is repeated in a state where the monitor value of the first order residual chromatic dispersion is determined to be equal to or less than the threshold value by the processing of steps S1 and S2, the dispersion slope monitor 213B can calculate the dispersion slope with high accuracy. When the monitor value of the first order residual chromatic dispersion becomes equal to or less than the threshold value and the monitor value of the dispersion slope becomes equal to or less than another threshold value (step S4: YES), the residual dispersion monitor 213A and the dispersion slope monitor 213B end the respective processes.

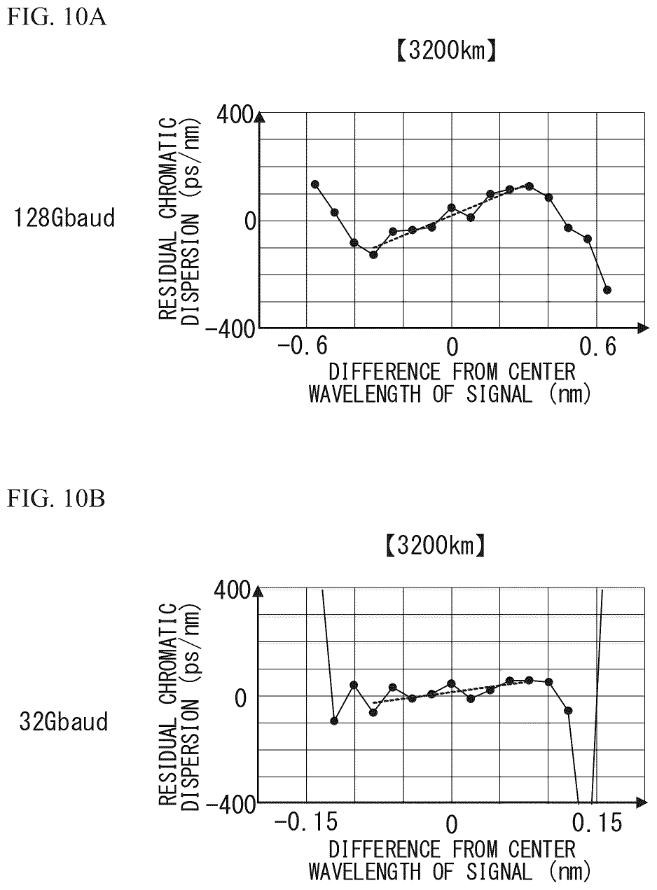

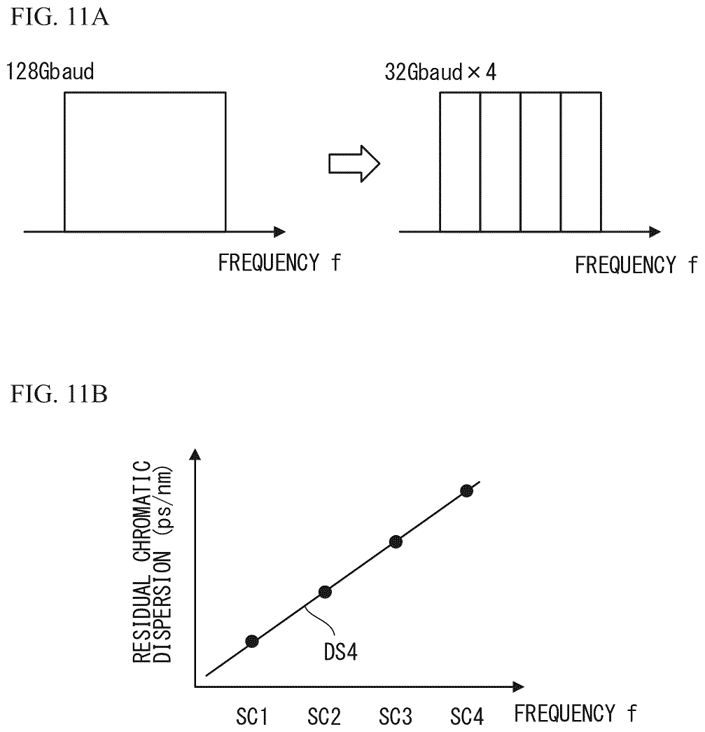

Next, the influence of the low baud rate will be described with reference to FIGS. 10A, 10B, 11A and 11B.

In the above embodiment, the monitoring value of the residual chromatic dispersion in the case of a high baud rate such as 128 Gbaud is described as shown in FIG. 10A. On the other hand, as shown in FIG. 10B, in the case of a low baud rate such as 32 Gbaud, the range of the signal band of the residual chromatic dispersion becomes narrow, so that the slope of the dispersion slope becomes small and the variation of the monitor value of the residual chromatic dispersion becomes large with respect to the slope of the dispersion slope. Thus, the accuracy of the dispersion slope calculation may be reduced.

The case of such a low baud rate occurs when subcarrier modulation is applied to the transmission of the optical signal O(t). For example, as shown in FIG. 11A, when subcarrier modulation is applied to the transmission of an optical signal O(t) of 128 Gbaud, which is a single carrier, the optical transmitter 100 divides the optical signal O(t) into four and transmits four optical signals O(t) of 32 Gbaud by the Frequency Division Multiplex (FDM) method. In this way, when the subcarrier modulation is applied, the calculation accuracy of the dispersion slope may be reduced.

In such a case, the dispersion slope monitor 213B calculates a dispersion slope based on the monitor value of the first order residual chromatic dispersion for each subcarrier. For example, as shown in FIG. 11B, the dispersion slope monitor 213B calculates the dispersion slope DS4 from the first order residual chromatic dispersion monitor values of the subcarriers SC1, SC2, SC3, and SC4 and the monitor values. The dispersion slope may be calculated by using a least square method or the like. The dispersion slope monitor 213B may input the dispersion slope DS4 to the dispersion compensation circuit 211.

As described above, according to the present embodiment, the optical receiver 200 includes the dispersion compensation circuit 211, the adaptive equalization circuit 212, and the monitor circuit 213. The dispersion compensating circuit 211 compensates for the chromatic dispersion of the optical fibers 51, 52, 53, 54 for the electric signal E(t) corresponding to the optical signal O(t) received through the optical fibers 51, 52, 53, 54. The adaptive equalization circuit 212 adaptively compensates for the residual chromatic dispersion remaining due to the lack of compensation in the dispersion compensation circuit 211 for the compensated electric signal E(t) by the dispersion compensation circuit 211. The monitor circuit 213 monitors the dispersion slope of the residual chromatic dispersion based on the tap coefficient of the adaptive equalizer circuit 212. The dispersion compensation circuit 211 compensates for the chromatic dispersion based on at least the monitor value of the dispersion slope. This makes it possible to suppress the deterioration of the transmission characteristic of the optical signal O(t).

Although the preferred embodiments of the present invention have been described above in detail, the present invention is not limited to the specific embodiments, and various modifications and changes are possible within the scope of the gist of the present invention described in the claims.

What is claimed is:

1. An optical receiver comprising:
a dispersion compensation circuit that compensates for chromatic dispersion of an optical transmission line, for an electric signal corresponding to an optical signal received through the optical transmission line;
an adaptive equalization circuit that adaptively compensates for residual chromatic dispersion remaining due to insufficient compensation in the dispersion compensation circuit, for a compensated electric signal by the dispersion compensation circuit; and
a monitor circuit that monitors a dispersion slope of the residual chromatic dispersion based on a tap coefficient of the adaptive equalizer circuit, wherein
the dispersion compensation circuit compensates for the chromatic dispersion based on a monitor value of the dispersion slope.

2. The optical receiver according to claim 1 wherein
the monitor circuit monitors the residual chromatic dispersion based on the tap coefficient, and
the dispersion compensation circuit compensates for the chromatic dispersion based on a monitor value of the dispersion slope and a monitor value of the residual chromatic dispersion.

3. The optical receiver according to claim 2 wherein
the monitor circuit calculates the residual chromatic dispersion and the dispersion slope by fitting a relationship between a monitor value of the residual chromatic dispersion and a difference from a center wavelength of the optical signal to a linear function.

4. The optical receiver according to claim 3 wherein
the monitor circuit determines a range in which the relationship matches the linear function based on a signal band of the optical transmission line.

5. The optical receiver according to claim 2, wherein
the monitor circuit calculates a monitor value of the dispersion slope after the monitor value of the residual chromatic dispersion is compensated to be equal to or less than a threshold value.

6. The optical receiver according to claim 2, wherein
the monitor circuit calculates a monitor value of the dispersion slope based on a monitor value of the residual chromatic dispersion for each subcarrier when subcarrier modulation is applied to the transmission of the optical signal.

7. An optical receiving method comprising:
compensating for chromatic dispersion of an optical transmission line, for an electric signal corresponding to an optical signal received through the optical transmission line;
adaptively compensating for residual chromatic dispersion remaining due to insufficient compensation in the dispersion compensation circuit, for a compensated electric signal;
monitoring a dispersion slope of the residual chromatic dispersion based on a tap coefficient of an adaptive equalizer circuit that adaptively compensates for the residual chromatic dispersion; and
compensating for the chromatic dispersion based on a monitor value of the dispersion slope.

8. The optical receiving method according to claim 7, wherein
the monitoring includes monitoring the residual chromatic dispersion based on the tap coefficient, and
the compensating includes compensating for the chromatic dispersion based on a monitor value of the dispersion slope and a monitor value of the residual chromatic dispersion.

9. The optical receiving method according to claim 8, wherein
the monitoring includes calculating the residual chromatic dispersion and the dispersion slope by fitting a relationship between a monitor value of the residual chromatic dispersion and a difference from a center wavelength of the optical signal to a linear function.

10. The optical receiving method according to claim 9, wherein
the monitoring includes determining a range in which the relationship matches the linear function based on a signal band of the optical transmission line.

11. The optical receiving method according to claim 8, wherein
the monitoring includes calculating a monitor value of the dispersion slope after the monitor value of the residual chromatic dispersion is compensated to be equal to or less than a threshold value.

12. The optical receiving method according to claim 8, wherein
the monitoring includes calculating a monitor value of the dispersion slope based on a monitor value of the residual chromatic dispersion for each subcarrier when subcarrier modulation is applied to the transmission of the optical signal.
